(19) United States
(12) Patent Application Publication
(10) Pub. No.: US 2005/0019244 A1
(43) Pub. Date: Jan. 27, 2005

(54) Method for the point of use production of ammonia from water and nitrogen

(76) Inventors: Jeffrey J. Spiegelman, San Diego, CA (US); Daniel Alvarez JR., San Diego, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/626,266

(22) Filed: Jul. 23, 2003

(51) Int. Cl. C01C 1/02

(52) U.S. Cl. 423/352

(57) ABSTRACT

The present invention discloses a method for the manufacture of high purity ammonia, hydrogen, and nitrogen from de-ionized water and standard nitrogen. De-ionized water is degassed and fed to an electrolytic hydrogen generator to produce raw hydrogen. The hydrogen is purified and mixed with purified nitrogen, compressed, and fed to a catalytic ammonia reactor. Following purification, the ammonia is delivered to the semiconductor process tool along with purified hydrogen and purified nitrogen.

### BACKGROUND OF THE INVENTION

1. Field of the Invention

The present invention generally relates to the manufacture of purified ammonia gas. More particularly, the present invention relates to the point of use production of purified ammonia gas from liquid water and nitrogen.

2. Background Art

There is considerable ongoing effort to develop and produce low cost, high performance (high output) light emitting diodes (LEDs). Such LEDs are intended for such disparate uses as in outdoor displays, vehicle lighting, flashlights, safety signaling systems, traffic signals, lasers, medical devices and indoor lighting. LEDs are expected to replace the current incandescent bulbs or fluorescent lighting tubes if they can reach the flux intensity and low cost of current bulbs. The advantage LEDs have is very low power and heat generation for a given light intensity, small size, and extremely long life well in excess of 50,000 hrs.

These LEDs are made by metal organic chemical vapor deposition (MOCVD) using materials such as gallium-, aluminum gallium- and indium gallium nitrides and phosphides. In a process currently of significant interest, gallium nitride is deposited from a gaseous mixture of ammonia, hydrogen and trimethyl gallium. Similar, gallium nitride is being considered for “blue lasers,” i.e. lasers which emit blue light. Because blue light has a shorter wavelength than red, yellow or green light, blue lasers are anticipated to be capable of forming compact disks which will have a much higher information density than is presently the case with compact disks produced with red laser light. Gallium nitride for such blue lasers would be manufactured in the same type of ammonia/hydrogen/trimethyl gallium gaseous environment as described above for the high capacity LEDs. A high purity supply of hydrogen, ammonia, and nitrogen is essential to production of these devices.

The LEDs, blue lasers and integrated circuits are all manufactured with electron accepting p-type dopants. Such products are extremely sensitive to the presence of electron-donating n-type materials, and very small concentrations of such n-type are sufficient to deactivate the p-type dopants and impair or destroy the performance and operability of the integrated circuits, LEDs and blue lasers. Oxygen is a particularly efficient n-type material, and the presence of molecular oxygen causes lattice defects and is detrimental to the desired band gap properties in the semiconductor or laser material. Even very low concentrations of oxygen (between 10 and 100 ppb) can be sufficient to cause sufficient reduction in performance or operability (especially in wavelength control) so as to require discarding of the product after manufacture or to significantly shorten operating lifetime

Similar detrimental effects are observed with the presence of sub ppm levels of water vapor, gaseous hydrocarbons and/or carbon dioxide gas in hydride gases such as ammonia, since those materials lead to degradation of the products formed by deposition of active layers of metals or metal compounds from a hydride gas environment. Water is one of the most common and yet most difficult impurities to remove from the gases, especially hydride gasses such as ammonia. In the manufacture of the semiconductor products described above, moisture contents of the depositing gases which are in the ppm range are excessively wet. To form satisfactory products, the water content of the depositing gases must be reduced to the parts per billion (ppb) range, usually down to no more than about 100 ppb. See Whitlock et al, “High Purity Gases,” in Ruthven, ed., Encyclopedia of Separation Technology, vol. 1, pp. 987-1000 (1997).

In most high-purity product manufacturing processes, it has been conventional for hydride gases to be stored in and supplied from standard gas cylinders. The volume of gas in each such cylinder is of course limited, so that in larger scale manufacturing processes, it becomes necessary for process operators frequently to replace emptied cylinders and replace them with fresh, full cylinders. This frequent handling and movement of heavy, awkward gas cylinders represents a safety hazard to the operators, as well as providing opportunities for gas leakage and increasing the cost of manufacturing. Also importantly, each time an empty gas cylinder is detached from the system and a new full cylinder attached, there is an opportunity for ambient contaminant gases, such as oxygen, carbon dioxide and water vapor, to enter the system, thus increasing the decontamination load on the system and accelerating the system degradation. Higher volume production may also require large banks of cylinders to be connected in parallel, increasing the probability of contamination problems, and making it very difficult to track down and replace a contaminated cylinder. The purity of gasses delivered in these cylinders may also be compromised due to out-gassing of impurities from the cylinder walls, since the container surface area to volume ratio is higher than for bulk delivery in large containers. This same effect can change the purity of cylinder stored gasses over time as well, since out-gassing impurities can increase impurity concentrations the longer a gas is stored. As the quantity of gas in the cylinder is reduced due to consumption, the impurity levels will also increase since the impurity desorption fluxes are being accumulated in a total quantity of gas that is decreasing. Gas delivered in cylinders is generally much more expensive than gas delivered in bulk, especially for premium high purity levels in low ppb ranges. The customer will pay a significant adder for delivery, onsite storage, and pickup of cylinders from the gas company.

The industry is beginning to require gases to be supplied in large volume containers which need to be changed only at infrequent intervals (usually measured in months rather than hours, as with the individual gas cylinders). A preferred type of large volume container is the “tube trailer,” a semi-trailer which is constructed with a number of “tubes,” high capacity extended high pressure vessels, which are interconnected or operate through a common manifold. A tube trailer can be parked at a manufacturing facility and attached to the gas supply system, and will typically have sufficient gas capacity to supply the hydride gas to the facility for a period of months. Bulk hydrogen may be delivered as pressurized gas in tube trailers or as a cryogenic liquid. Liquid hydrogen requires sophisticated, expensive storage requirements and is not widely distributed throughout the world. However, even these bulk delivery systems can introduce contamination every time a new container is connected or disconnected from the plant, or the cryogenic fluid is replenished. Furthermore, contamination can be introduced in the piping systems that deliver the bulk gas to the point of use, or process tool. Removing and controlling this contamination requires the use of distributed purifiers, which may be placed at multiple locations in the distribution system. While effective in controlling contamination, this distributed purification scheme can be expensive to purchase, install, and maintain.

It would be of interest, for the flexible, low cost production of high performance LEDs and blue lasers, to manufacture high purity ammonia, hydrogen, and nitrogen from de-ionized (DI) water and standard nitrogen. Point of use production eliminates the contamination associated with delivery from bulk storage and cylinders, and the need for layers of distributed purification. De-ionized water and standard purity nitrogen are very common reagents and are universally available in all semiconductor plants. Furthermore, point of use production of high purity ammonia, hydrogen, and nitrogen from DI water is suitable for plants being set up in countries where there is limited chemical industry infrastructure, and the production of high purity gasses does not exist.

### SUMMARY OF THE INVENTION

It is an object of the present invention to provide a method for the manufacture of high purity ammonia, hydrogen, and nitrogen from de-ionized (DI) water and standard nitrogen. In a first embodiment of the present invention, the method comprises the steps of feeding a quantity of de-ionized water to a hydrogen generator, producing hydrogen from the de-ionized water, and purifying the hydrogen with a hydrogen purifier. The method further comprises producing purified nitrogen by passing standard quality nitrogen through a nitrogen purifier and, contacting the purified hydrogen and purified nitrogen with a catalyst bed, wherein a portion of the purified hydrogen purified nitrogen react to form a quantity of ammonia.

In another embodiment of the present invention, the method comprises the steps of de-gassing the de-ionized water to remove a portion of dissolved gasses, feeding the de-ionized, de-gassed water to a hydrogen generator, and producing hydrogen from the de-ionized, de-gassed water. The method further comprises producing a quantity of purified hydrogen by passing the hydrogen through a hydrogen purifier, producing purified nitrogen by passing standard quality nitrogen through a nitrogen purifier, compressing said the purified hydrogen and the purified nitrogen, and contacting the compressed purified hydrogen and purified nitrogen with a catalyst bed, wherein a portion of the purified hydrogen and a portion of the purified nitrogen react to form a quantity of ammonia. Purified ammonia is produced by passing the ammonia through an ammonia purifier and then delivered to a semiconductor process tool.

### BRIEF DESCRIPTION OF THE DRAWINGS

The present invention will be better understood when consideration is given to the following detailed description thereof. Such description makes reference to the annexed drawings, wherein:

FIG. 1 is a schematic flow diagram of a process for making purified nitrogen, hydrogen, and ammonia from water and nitrogen, in accordance with an embodiment of the present invention;

FIG. 2 is a schematic diagram of the regenerable purifiers of FIG. 1, in accordance with an embodiment of the present invention; and,

FIG. 3 is a process flow diagram for the manufacture of purified nitrogen, hydrogen, and ammonia from water and nitrogen, in accordance with an embodiment of the present invention.

### DETAILED DESCRIPTION OF THE PREFERRED EMBODIMENTS

It is an object of the present invention, useful for the flexible, low cost production of high performance LEDs and blue lasers, to provide a method for the manufacture of high purity ammonia, hydrogen, and nitrogen from de-ionized (DI) water and standard nitrogen. Point of use production eliminates the contamination associated with delivery from bulk storage and cylinders, and the need for layers of distributed purification. De-ionized water and standard purity nitrogen are very common reagents and are universally available in all semiconductor plants. Furthermore, point of use production of high purity ammonia, hydrogen, and nitrogen from DI water and standard nitrogen is suitable for plants being set up in countries where there is limited chemical industry infrastructure, and the production and distribution of ultra high purity gasses does not exist.

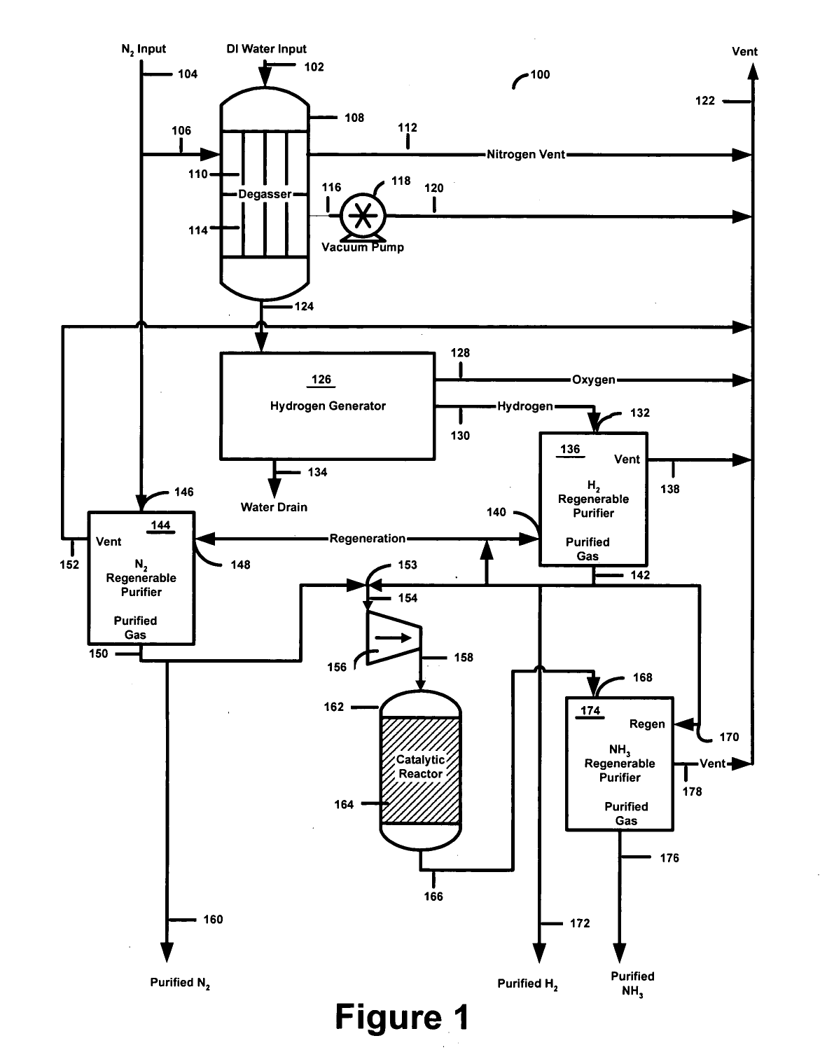

FIG. 1 is a schematic flow diagram 100 of a process for making purified nitrogen, hydrogen, and ammonia from water and nitrogen, in accordance with an embodiment of the present invention. De-ionized (DI) water is introduced to the process at input 102, and fed to de-gassing unit 108 (degasser). The degasser 108 is a two stage device that strips dissolved gasses from the DI water with nitrogen in a first stage 110, followed by vacuum stripping in a second stage 114. As an example, degasser 108 may be a membrane contactor available from Liqui-Cel®. In the first stage 110 nitrogen is introduced at input 106, purged though the system, and vented at 112. In the second stage 114, a vacuum pump 118 is connected to input 116 and vented through line 120. Typically, dissolved gasses leaving the degasser 108 have less than 1 ppb oxygen, and 1 ppm CO₂.

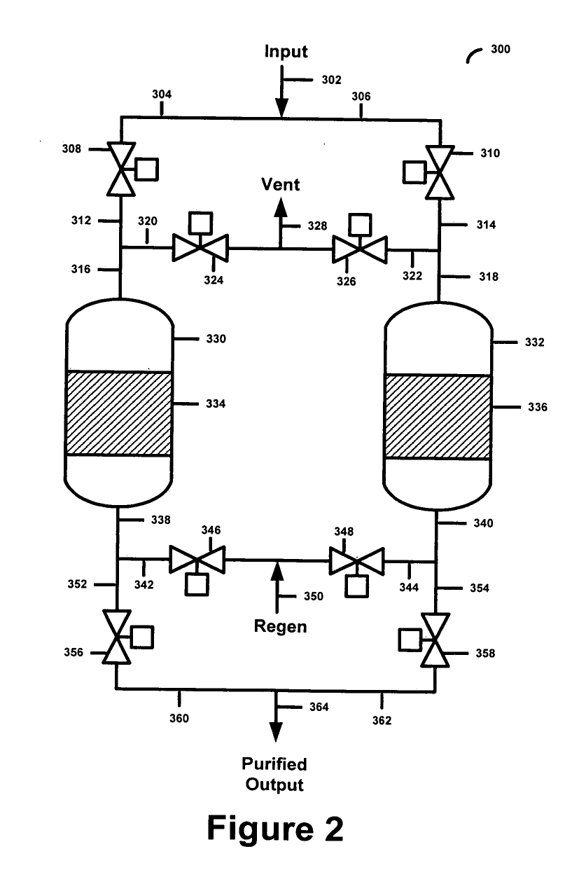

De-gassed water 124 leaving the degasser 108 is introduced to the hydrogen generator 126. In the hydrogen generator, water is de-composed to hydrogen gas and oxygen gas by electrolytic means, as is well known to those skilled in the art. For example, a hydrogen generator 126 manufactured by Proton Energy Systems (as the HOGEN® line of hydrogen generators) may be used. Hydrogen gas produced by the generator has a typical water impurity level of less than 5 ppm, and an oxygen impurity level of less than 1 ppm. These impurity levels are too high for end use and require further purification. Hydrogen delivery pressures are typically less than 14 bar. Oxygen produced by generator 126 is vented via output 128. Excess water is drained via output 134. The hydrogen output 130 is fed to input 132 of the hydrogen regenerable purifier 136. The detailed configuration of the regenerable purifiers is shown below in FIG. 2. In the hydrogen purifier, the feed hydrogen at input 132 is passed through one or more adsorption beds filled with purification media. The media may be composed of high surface area oxides chosen from among oxides of barium, calcium, iron, lithium, manganese, molybdenum, potassium, rhenium, sodium, strontium, titanium, tungsten, and vanadium, as disclosed in U.S. Pat. No. 6,241,955. Alternatively, the media may be composed of nickel metal and nickel oxide supported on a high surface area substrate as disclosed in U.S. Pat. No. 4,713,224 in combination with titanium oxides as disclosed in U.S. Pat. No. 6,059,859. Hydrogen purifier 136 removes impurities such as H₂O, CO, CO₂, O₂ and hydrocarbons. Remaining impurity levels in the purified hydrogen output 142 are less than 100 ppb, but preferably less than 10 ppb, and more preferably less than 1 ppb. Hydrogen purifier 136 has a regeneration gas input 140, and utilizes purified hydrogen from the output 142 for regeneration. Regeneration gasses are vented at output 138 to system vent 122.

The purified hydrogen output at 142 is delivered to a number of locations within process 100. It is utilized for regeneration of the nitrogen purifier 144 (at input 148), regeneration of the ammonia purifier 174 (at input 170), to compressor 156 for the production of ammonia, and for delivery to the process tool at output 172.

Nitrogen fed to the process 100 at input 104 is fed to the nitrogen regenerable purifier 144 at input 146. The detailed configuration of the regenerable purifiers is shown below in FIG. 2. In the nitrogen purifier, the feed nitrogen at input 146 is passed through one or more adsorption beds filled with purification media. The media may be composed of nickel metal and nickel oxide supported on a high surface area substrate as disclosed in U.S. Pat. No. 4,713,224. Other media may also be utilized as may be known to those skilled in the art. Nitrogen purifier 144 removes impurities such as H₂O, CO, CO₂, O₂ and hydrocarbons. Remaining impurity levels in the purified nitrogen output 150 are less than 100 ppb, but preferably less than 10 ppb, and more preferably less than 1 ppb. Nitrogen purifier 144 has a regeneration gas input 148, and utilizes purified hydrogen from the hydrogen purifier 136 for regeneration. Regeneration gasses are vented at output 152 to system vent 122. The purified nitrogen at output 150 is delivered to multiple locations within process 100. Purified nitrogen is supplied to the point of use at output 160, and to mixing point 153 where it is added to the purified hydrogen prior to compressor input 154. Purified nitrogen may also be used in various purge functions in purifiers 136, 144, and 174 (not shown), and optionally may be used for degassing the DI water as well.

Purified nitrogen and purified hydrogen is mixed at 153 and fed to compressor input 154. Due to the high purity requirements of the end product ammonia, compressor 156 should produce as little contamination as possible. An air driven diaphragm compressor, such as that made by Haskell, would be suitable. Other types may also be utilized, if suitable contamination levels can be maintained. Pressure levels exiting compressor 156 should be below 100 bar, preferably in the range of 30 to 80 bar. The compressed nitrogen/hydrogen mixture exits the compressor at 158 and enters the ammonia reactor 162. Stoichiometric requirements for the production of pure ammonia necessitate a mole ratio of 3:1 hydrogen/nitrogen. The actual ratios may vary, depending on the conversion to ammonia and the amount of unreacted nitrogen and or hydrogen desired in the product stream. In the present invention, the product ammonia is primarily utilized for the point of use production of MOCVD films, where hydrogen and/or nitrogen are often mixed with ammonia prior to entry into the deposition chamber. The ammonia production process can therefore be tailored to the downstream CVD process, and the requirements for 100% ammonia conversion is not a strict requirement. Subsequently, the extreme conditions required by industrial ammonia production processes which include the complete separation of ammonia from unreacted hydrogen and nitrogen, and the recycle of theses gasses back to the reactor input, are not required in the present invention. Ammonia reactor 162 contains a heated catalyst bed where the hydrogen/nitrogen is reacted to form ammonia. As mentioned previously, 100% conversion to ammonia may not be required. Operating conditions of the catalyst bed would include an operating total pressure below 100 bar, preferably in the range of 30 to 80 bar, most preferably 50 bar; an operating temperature in the range of 50 to 400° C., preferably 100° C. The catalyst bed 164 may comprise a standard iron oxide (magnetite) ammonia catalyst, a precious metal (platinum or palladium) promoted iron oxide catalyst, or ruthenium supported on carbon, alumina, or zeolites. These catalysts may be used alone or in combination. Other catalysts may also be used as disclosed or known in the art.

Ammonia and any unreacted nitrogen and hydrogen exit the ammonia reactor at 166 and enter the ammonia purifier 174 at input 168. The detailed configuration of the regenerable purifiers is shown below in FIG. 2. In the ammonia purifier, the feed ammonia mixture at input 174 is passed through one or more adsorption beds filled with purification media. The media is composed of high surface area oxides chosen from among oxides of barium, calcium, iron, lithium, manganese, molybdenum, potassium, rhenium, sodium, strontium, titanium, tungsten, and vanadium, as disclosed in U.S. Pat. No. 6,241,955. Ammonia purifier 174 removes impurities such as H₂O, CO, CO₂, O₂ and hydrocarbons. Any hydrogen and nitrogen within the ammonia are “transparent” to the purifier and are not considered impurities. That is, they are not removed by the ammonia purifier, and are purified as well. Remaining impurity levels in the purified ammonia output 176 are less than 100 ppb, but preferably less than 10 ppb, and more preferably less than 1 ppb. Ammonia purifier 174 has a regeneration gas input 170, and utilizes purified hydrogen from the hydrogen purifier output 142 for regeneration. Regeneration gasses are vented at output 178 to system vent 122. The purified ammonia is delivered to the point of use via output 176.

FIG. 2 is a schematic diagram of the regenerable purifiers 136, 144, and 174 of FIG. 1, in accordance with an embodiment of the present invention. As an example, assume that vessel 330 is purifying and vessel 332 is regenerating. Gas to be purified enters input 302 and is directed to adsorption vessels 330 via valves 308 and lines 304, 312, and 316. The gas is passed through adsorption bed 334 and is purified, leaving the vessel 330 at output 338. The purified gas passes through valve 356 via lines 352 and 360 to output 364. Valves 324 and 346 are closed to prevent contamination from the vent and regeneration gasses. While in the purification mode for vessel 330, vessel 332 may or may not be regenerating, depending on the purification capacity of the adsorption beds. As another example, assume that vessel 332 is regenerating. Regeneration gas enters input 350 and is directed through valve 348 to vessel 332 via line 340. After passing though bed 336, the regeneration gas and impurities extracted form bed 336 exit vessel 332 at input 318, and exit the system to vent 328 through valve 326 and line 322. Bed 336 may or may not be heated during regeneration, but preferably is heated. The pressure utilized during regeneration is usually close to 1 bar, to aid in the desorption of impurities from the bed media. Valves 310 and 358 remain closed during regeneration to prevent contamination of the product and inlet gas steams. Their closure is also required to maintain the pressure differential between the product gas (at approximately 10 bar) and the regeneration at approximately 1 bar. In the illustrated configuration, the regeneration stream is counter-current to the purification flow through the bed 336. However, it is also possible to introduce the regeneration gas to input 328 for co-current regeneration.

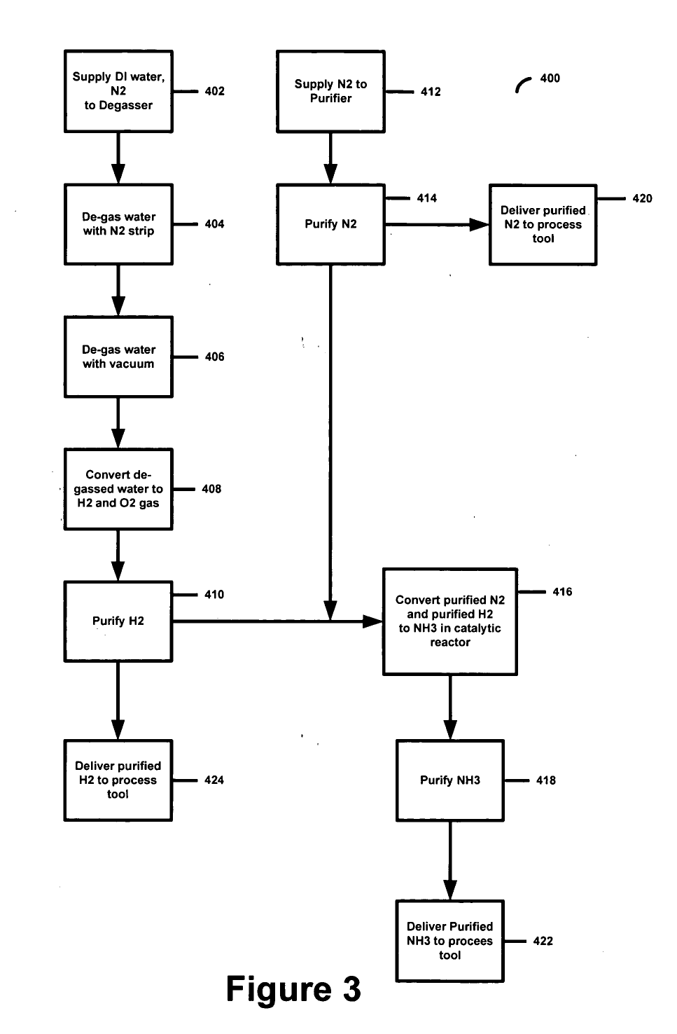

FIG. 3 is a process flow diagram 400 for the manufacture of purified nitrogen, hydrogen, and ammonia from water and nitrogen, in accordance with an embodiment of the present invention. In step 402, DI water is supplied to the de-gassing unit. In step 404, the water is de-gassed in a first stage using a nitrogen strip. In step 406, the DI water is further de-gassed in a second stage using a vacuum. In step 408, the de-gassed, DI water is converted to gaseous hydrogen and oxygen in the hydrogen generator. In step 410, the hydrogen is purified. In step 412, standard purity nitrogen is supplied to the nitrogen purifier. In step 414, the nitrogen is purified. The purified nitrogen from step 414 and the purified hydrogen from step 410 are converted to ammonia in step 416. The ammonia is purified in step 418, and delivered to the process tool in step 422. Purified hydrogen from step 410 is delivered to the process tool in step 424. Purified nitrogen from step 414 is delivered to the process tool in step 420.

While various embodiments have been described above, it should be understood that they have been presented by way of example only, and not limitation. Thus, the breadth and scope of an embodiment of the present invention should not be limited by any of the above described exemplary embodiments, but should be defined only in accordance with the following claims and their equivalents.

1. A method for producing ammonia gas from liquid water and nitrogen, comprising the steps of:
feeding a quantity of de-ionized water to a hydrogen generator;
producing a quantity of hydrogen from the quantity of de-ionized water utilizing said hydrogen generator;
producing a quantity of purified hydrogen by passing said quantity of hydrogen through a hydrogen purifier;
producing a quantity of purified nitrogen by passing a quantity of nitrogen through a nitrogen purifier; and,
contacting said quantity of purified hydrogen and said quantity of purified nitrogen with a catalyst bed, wherein a portion of said purified hydrogen and a portion of said purified nitrogen react to form a quantity of ammonia.

2. The method as recited in claim 1, further comprising the step of:
de-gassing said quantity of de-ionized water prior to feeding the de-ionized water to said hydrogen generator, to remove a portion of dissolved gasses in said quantity of de-ionized water.

3. The method as recited in claim 2, wherein said quantity of de-ionized water is de-gassed in a membrane contactor, having a first stage followed by a second stage.

4. The method as recited in claim 3, wherein in said first stage, a first portion of said dissolved gassed are removed by nitrogen stripping.

5. The method as recited in claim 3, wherein in said second stage, a second portion of said dissolved gasses are removed by vacuum stripping.

6. The method as recited in claim 1, further comprising the step of:
compressing said quantity of purified hydrogen and said quantity of purified nitrogen prior to contacting said quantity of purified hydrogen and said quantity of purified nitrogen with said catalyst bed.

7. The method as recited in claim 6, wherein said quantity of purified hydrogen and said quantity of purified nitrogen are compressed to a pressure between 10 and 100 atmospheres, absolute.

8. The method as recited in claim 1, further comprising the step of:
producing a quantity of purified ammonia by passing said quantity of ammonia through an ammonia purifier.

9. The method as recited in claim 8, further comprising the step of:
delivering a portion of said quantity of purified ammonia to a semiconductor process tool.

10. The method as recited in claim 8, wherein said ammonia purifier comprises a high surface area metal oxide comprising oxides of barium, calcium, iron, lithium, manganese, molybdenum, potassium, rhenium, sodium, strontium, titanium, tungsten, and vanadium.

11. The method as recited in claim 8, wherein at least one of said ammonia purifier, said hydrogen purifier, and said nitrogen purifier are regenerated with a portion of said quantity of purified hydrogen.

12. The method as recited in claim 8, wherein the concentration of an impurity in said quantity of purified ammonia is reduced to less than 50 ppb.

13. The method as recited in claim 8, wherein the concentration of an impurity in said quantity of purified ammonia is reduced to less than 10 ppb.

14. The method as recited in claim 1, wherein said hydrogen purifier comprises:
a high surface area metal oxide comprising oxides of barium, calcium, iron, lithium, manganese, molybdenum, nickel, potassium, rhenium, sodium, strontium, titanium, tungsten, and vanadium; and,
optionally, metallic nickel.

15. The method as recited in claim 1, wherein said nitrogen purifier comprises a nickel catalyst.

16. The method as recited in claim 1, wherein said hydrogen generator produces hydrogen from water by electrolytic means.

17. The method as recited in claim 1, wherein the concentration of an impurity in said quantity of purified hydrogen is reduced to less than 50 ppb.

18. The method as recited in claim 1, wherein the concentration of an impurity in said quantity of purified nitrogen is reduced to less than 50 ppb.

19. The method as recited in claim 1, wherein the concentration of an impurity in said quantity of purified hydrogen is reduced to less than 10 ppb.

20. The method as recited in claim 1, wherein the concentration of an impurity in said quantity of purified nitrogen is reduced to less than 10 ppb.

21. A method for producing point of use ammonia gas from liquid water and nitrogen, comprising the steps of:
de-gassing a quantity of de-ionized water, to remove a portion of dissolved gasses in said quantity of de-ionized water;
feeding a quantity of said de-ionized, de-gassed water to a hydrogen generator;
producing a quantity of hydrogen from the quantity of said de-ionized, de-gassed water utilizing said hydrogen generator;
producing a quantity of purified hydrogen by passing said quantity of hydrogen through a hydrogen purifier;
producing a quantity of purified nitrogen by passing a quantity of nitrogen through a nitrogen purifier;
compressing said quantity of purified hydrogen and said quantity of purified nitrogen;
contacting said compressed quantity of purified hydrogen and said compressed quantity of purified nitrogen with a catalyst bed, wherein a portion of said purified hydrogen and a portion of said purified nitrogen react to form a quantity of ammonia;
producing a quantity of purified ammonia by passing said quantity of ammonia through an ammonia purifier; and,
delivering a portion of said quantity of purified ammonia to a semiconductor process tool.
